(19) United States
(12) Patent Application Publication
(10) Pub. No.: US 2016/0304367 A1
(43) Pub. Date: Oct. 20, 2016

(54) Self-Dispersing Additive System, Composition, and Method for Treating Bodies of Water

(71) Applicant: NCH Corporation, Irving, TX (US)

(72) Inventors: Kelly A. Gillespie, Richardson, TX (US); Christina Bond Burton, Bedford, TX (US); Spencer Naquin, Irving, TX (US); Jonathan James B. Aykroyd, Sao Jose do Rio Preto (BR); Alex Erdman, Irving, TX (US); Lyle Steimel, Flower Mound, TX (US); Robert C. Pearce, Arlington, TX (US)

(21) Appl. No.: 14/689,790

(22) Filed: Apr. 17, 2015

(51) Int. Cl. C02F 1/68; A01N 25/34; B65D 65/46; A01N 25/30; C02F 1/66; C02F 1/50; A01N 25/12; A01N 37/36

(52) U.S. Cl. CPC C02F 1/685; A01N 25/12; A01N 25/34; A01N 37/36; A01N 25/30; C02F 1/66; C02F 1/50; B65D 65/46; C02F 2303/04; C02F 2303/22

(57) ABSTRACT

A system, composition and method of treating a body of water with an active in a tablet form or contained in a water soluble container to improve overall water quality and ensure adequate dispersion of the active. The composition preferably comprises active(s) and an effervescent couple in solid form. The method preferably comprises dispensing a treatment composition by dropping or throwing the pellets or water soluble containers into the water. The water soluble containers preferably are bag-within-a-bag containers, with an inner bag and outer bag each having the treatment composition and air. Upon contact with the water, the effervescent couple will react to form carbon dioxide, which aids in dispersing the active and any optional ingredients in the treatment composition throughout the water.

### BACKGROUND OF THE INVENTION

1. Field of the Invention

This invention relates to a self-dispersing additive system, composition, and method for treating bodies of waters, such as ponds, lakes, cooling towers, lagoons, wastewaters, decorative fountains, hot tubs, chilled water systems, and swimming pools, with one or more additives, such fish food, probiotics, algaecides, corrosion inhibitors, and calcified seaweed, that provide a treatment or benefit for the body of water or plants and animals living in or drinking from the body of water.

2. Description of Related Art

The use of chemicals to treat bodies of water, such as ponds or lakes, cooling towers, or water systems, such as tanks in a wastewater treatment system, is well known. Water treatment systems generally involve manual or automatic systems for the addition of liquid and solid compounds. The manual process involves physically dumping the additives into the water and automated systems typically use pumps the transfer the additives from a storage container to the body of body. Although these application methods are relatively easy, a major drawback of these methods is insufficient dispersal of the treatment product throughout the body of water. Natural water movements are generally insufficient to achieve adequate dispersal. Additionally, natural water movements, such as a current created by wind, may result in the product being primarily directed to a single area within the body of water rather than dispersed throughout the body of water. To achieve sufficient dispersal, the addition of pumping or mixing equipment may be necessary, which adds to the costs and maintenance of the body of water. Additionally, there is no easy way of dispensing a powder, liquid, solid or slurry treatment product in the middle of a large body of water without using additional equipment such as a boat or piping system. These methods may also result in the loss of some treatment product because the product may be blown away (such as by wind) during application to the body of water or during on-site preparation of a slurry to be pumped or manually dumped into the body of water. There is a need for a simple method of delivering treatments to bodies of waters and water systems that will aid in dispersal, allow dispensing at multiple locations, reduce the need for manual labor, and reduce treatment product losses without requiring the use of expensive pumping or mixing equipment.

### SUMMARY OF THE INVENTION

This invention provides a system, composition, and method to treat bodies of water, such as ponds, pools, fountains, hot tubs and lakes, or water systems, such as tanks within wastewater treatment plants or cooling towers, with additives that provide a treatment or benefit for the body of water or plants and animals living in or drinking from the body of water, such as improving water quality, improving overall health of the water, or delivering food or probiotics. An additive composition according to a preferred embodiment of the invention comprises one or more treatment additive which can both biological, chemical, or a combination, and other components that effervesce in the presence of water to aid in dispersal of the additives. A delivery system according to a preferred embodiment of the invention comprises forming a composition comprising one or more treating additives and effervescing compounds as tablets, pucks, powders, granules, or bricks which are encapsulated or otherwise contained in a water soluble capsule, pouch, or other container or form that will dissolve upon contact with water to allow the composition to effervesce and disperse the additive through the body of water.

According to a preferred method of the invention, a body of water is treated with one or more treatment additives, such as calcified seaweed, scale inhibitors, corrosion inhibitors, or other beneficial compounds, by dispensing or depositing product filled water soluble containers into the water. Most preferably, multiple such containers are deposited, such as by throwing them into the water, at various locations around the perimeter and at various locations across the length and width of the body of water. According to another preferred method of the invention, a body of water is treated with an additive by depositing water soluble containers comprising an effervescing composition into the body of water, preferably using multiple containers of the composition deposited at multiple locations, with the effervescing action aiding in dispersing the additives in the body of water.

The preferred systems, compositions, and treatment methods provide an easy way to disperse one or more treating additives in a body of water, including into a middle section or portion of the body of water not easily reachable by an outer perimeter or shoreline. The use of water soluble containers eliminates product loss issues associated with using a powdered, liquid, slurry, or granulated product. The water soluble containers may range in size and weight from smaller, very light-weight tablet sizes to larger pouches weighing from 0.01 to 5.0 pounds, but are most preferably sized to be easily picked up and thrown a distance into a body of water by the average adult. The effervescent components used in a preferred embodiment also aid in dispersal of the additive(s) without requiring the use or addition of any pumping or mixing equipment.

### BRIEF DESCRIPTION OF THE DRAWINGS

The system of the invention is further described and explained in relation to the following drawings wherein:

FIG. 1 is a front elevation view of a delivery system according to one preferred embodiment of the invention, showing interior portions of the delivery system in dotted lines;

FIG. 2 is a perspective view the delivery system of FIG. 1, showing interior portions of the delivery system in dotted lines;

FIG. 3 is a front elevation view a delivery system according to another preferred embodiment of the invention, showing interior portions of the delivery system in dotted lines;

FIG. 4 is a perspective view of the delivery system of FIG. 3, showing interior portions of the delivery system in dotted lines;

FIG. 5 is a front elevation view of a delivery system according to another preferred embodiment of the invention, showing interior portions of the delivery system in dotted lines;

FIG. 6 is a perspective view of the delivery system of FIG. 5, showing interior portions of the delivery system in dotted lines;

FIG. 7 is a front elevation view of a delivery system according to another preferred embodiment of the invention, showing interior portions of the delivery system in dotted lines;

FIG. 8 is a perspective view of the delivery system of FIG. 7, showing interior portions of the delivery system in dotted lines;

FIG. 9 is a front elevation view of a delivery system according to another preferred embodiment of the invention, showing interior portions of the delivery system in dotted lines; and

FIG. 10 is a perspective view of the delivery system of FIG. 9, showing interior portions of the delivery system in dotted lines.

### DESCRIPTION OF THE PREFERRED EMBODIMENTS

A composition according to one preferred embodiment of the invention comprises one or more treatment additives (an active ingredient) and an effervescent couple. Any type of treatment additive or active ingredient may be used, including without limitation, fish food, probiotics, antibiotics, biocides, algaecides, herbicides, biologicals, chelating agents, scale inhibitors, corrosion inhibitors (such as tolyltriazole or benzotriazole), water softeners, antifoam, chemicals, ph adjusters, and calcified seaweed. The composition according to this preferred embodiment may also include a dye. Any suitable dye may be used to provide a visual indication of dispersion of the treatment additive in the body of water. A reactive dye may also be used as an active ingredient to indicate the presence of certain components in the water being treated.

The effervescent couple comprises a solid acidic and a solid basic material. When these two materials dissolve in water, they react with one another to produce carbon dioxide resulting in effervescence. Preferably, the acid is one or more of citric acid, malic acid, maleic acid, or fumaric acid, but other acids may also be used. Preferably, the basic component is an alkali or alkaline carbonates or bicarbonates, such as sodium bicarbonate or calcium carbonate, but other basic components may also be used. Citric acid and sodium bicarbonate are the most preferred effervescent couple because of their rapid reaction together.

Preferably, the composition comprises about 0.01 to 80% total of one or more active ingredients, about 10 to 34% solid acid, and about 20 to 66% solid basic compound. The percentages herein are by % weight.

A composition according to another preferred embodiment of the invention comprises calcified seaweed as the active treatment additive. Calcified seaweed may be used to provide several benefits to the body of water, including pH modification, macronutrient addition to benefit fish and bacteria populations, and odor reduction. Most preferably, the calcified seaweed composition comprises about 0.8 to 70% calcified seaweed and effervescent couple comprising about 5 to 10% solid acid and about 10 to 20% solid basic compound, all by weight. Any effervescent couple may be used, but sodium bicarbonate and citric acid are preferred. When sodium bicarbonate and citric acid are used as the effervescent couple, they are preferably added in a 2:1 ratio and the calcified seaweed (biological material) being at least 70% of the composition. Optionally, other ingredients, including other active or inactive ingredients (such as tolyltriazole, or benzotriazole, or a dye), may be added to the composition. When other optional ingredients are included the composition, the amount of calcified seaweed and effervescent couple by weight percentage will vary, but are preferably maintained in a ratio of about 50:16:34 to about 80:6:14 (calcified seaweed:acid:basic compound).

A composition according to another preferred embodiment of the invention comprises as the active ingredients a first chelating agent in a concentration of around 30 ppm to around 120 ppm, a second chelating agent in a concentration of around 680 ppm to 2700 ppm, and an anionic surfactant in a concentration of around 50 ppm to 200 ppm. This preferred embodiment also includes an effervescent couple, as previously described. The first chelating agent is preferably an organic acid and the second chelating agent is preferably the corresponding neutral salt of the first agent. Citric acid and sodium citrate are the preferred chelating agents. The preferred surfactant is an anionic naphthalene sulfonate compound. Optionally and preferably, this composition also includes a corrosion inhibitor, such as a tolytriaole, in a concentration of around 1 ppm to 20 ppm. Optionally, a biocide may also be used. This treatment composition is particularly useful in treating cooling tower water and for removing biofilms within such towers, but may also be used to treat other bodies of water. The concentrations herein are the concentrations of the ingredients when added to the body of water, such as the volume of water in a cooling tower system, being treated.

When the treatment compositions according to the invention are added to water, the chemical reaction of the effervescent couple in water releases carbon dioxide which aids in the rapid and even dispersion of the treatment composition in the body of water. Although the compositions comprising an active and effervescent couple (along with any other optional ingredients) according to the embodiments of the invention may be added to a body of water as a dry, loose powder, these ingredients are most preferably uniformly mixed as dry, loose ingredients sealed or encapsulated in a water soluble container, such as a capsule, pouch, or bag. Such water soluble containers would dissolve upon contact with water (when they are dispensed or added to the body of water being treated) and allow the effervescent action to begin. These water soluble containers are not packed tightly, but are loosely package with the components and air to augment the float characteristics of the system. Loose product packing is preferred to insure buoyance of the total system. If powdered material is placed into a water soluble container or capsule, it will float and allow the powder to effervesce from the surface of the water once the water has penetrated the outside of the capsule or water soluble container. The inherent buoyance and the release of insitu gas product will act a propellant to transport the released actives through the body of water. A water soluble capsule may be made of PVA, cellulose, or other similar materials that safely degrade rapidly in an aqueous environment. Although water soluble capsules are preferred for this application, there are many other ways to package or contain this invention. PVA bags and cellulose bags are examples of other types of containment.

Although the treatment compositions are preferably loose ingredients within the water soluble container, one or more of them may be pressed into pellets or capsule or the like prior to be placed in the container. References herein to “pellets” include any compacted form of the treatment composition, such as tablets, puck, or bricks, which are pressed together and not coated with or sealed in any water soluble material.

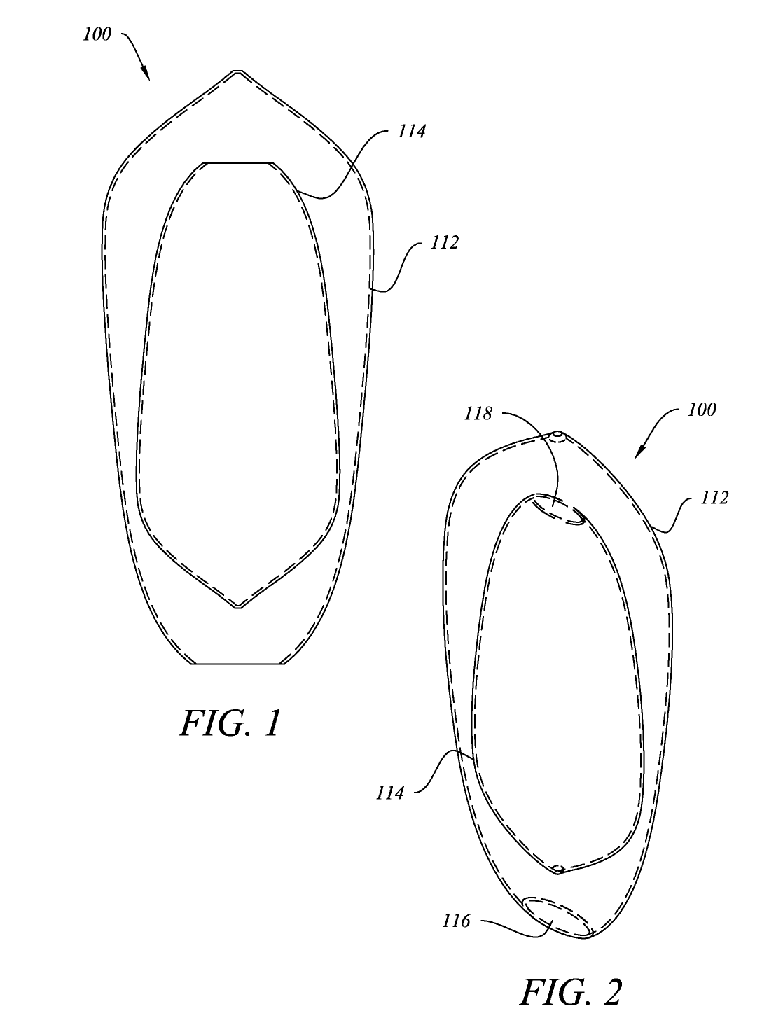

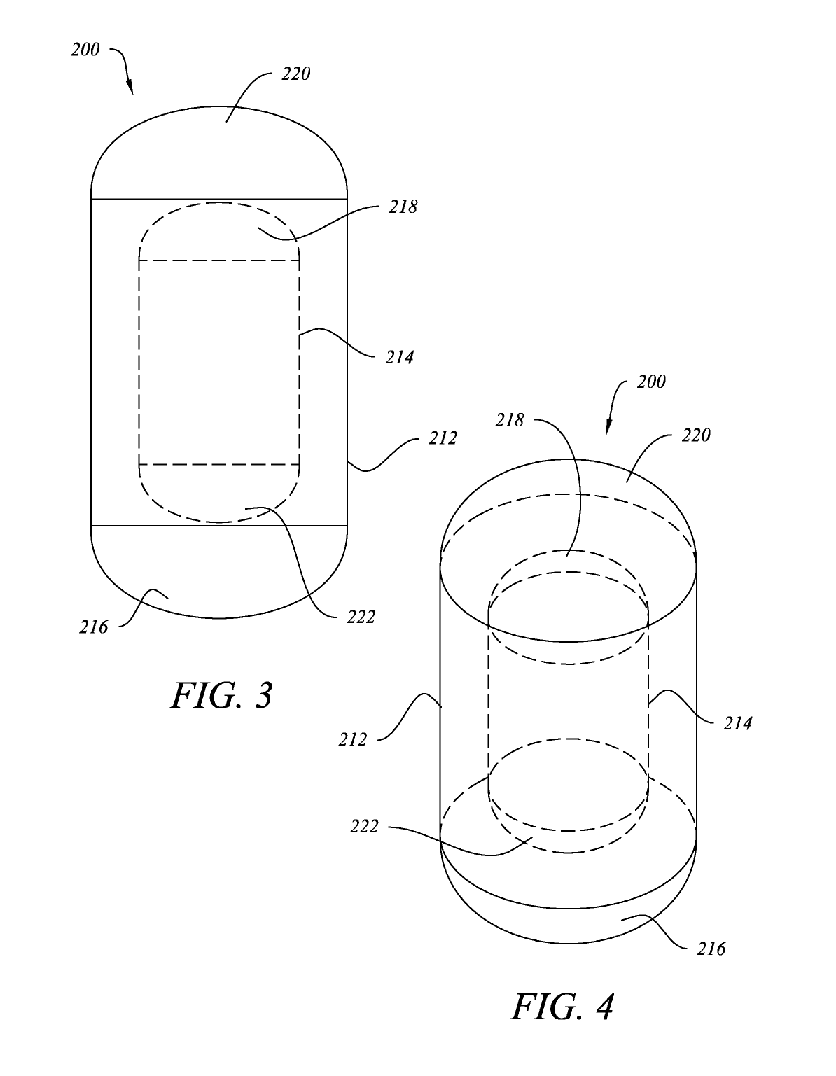

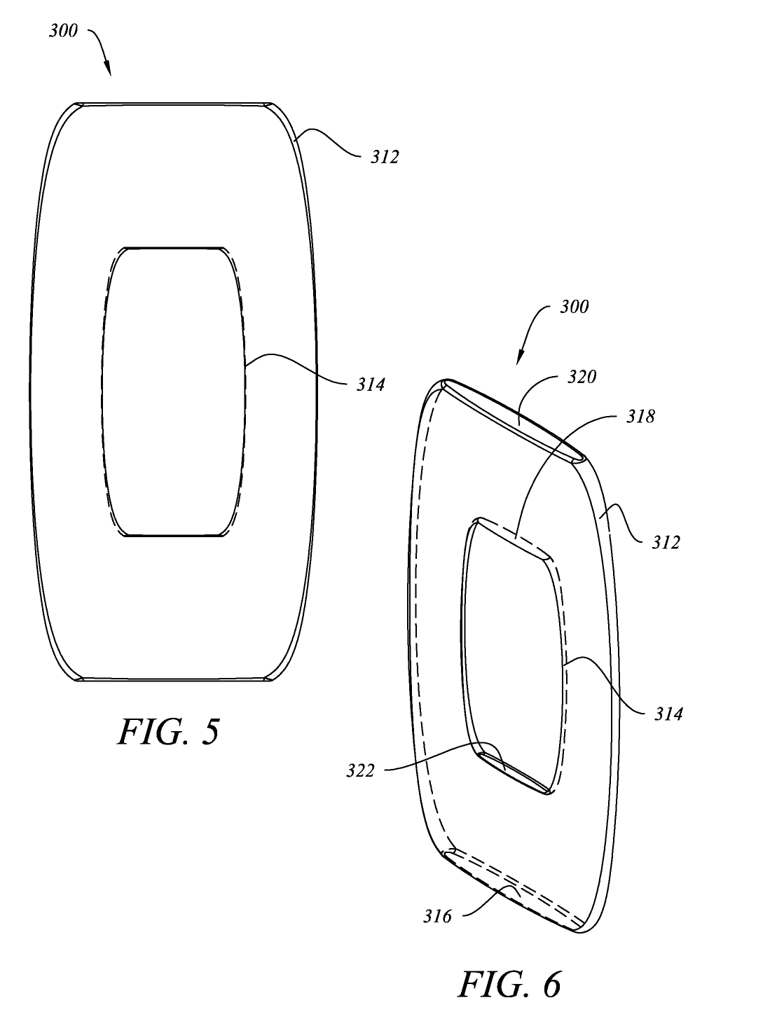

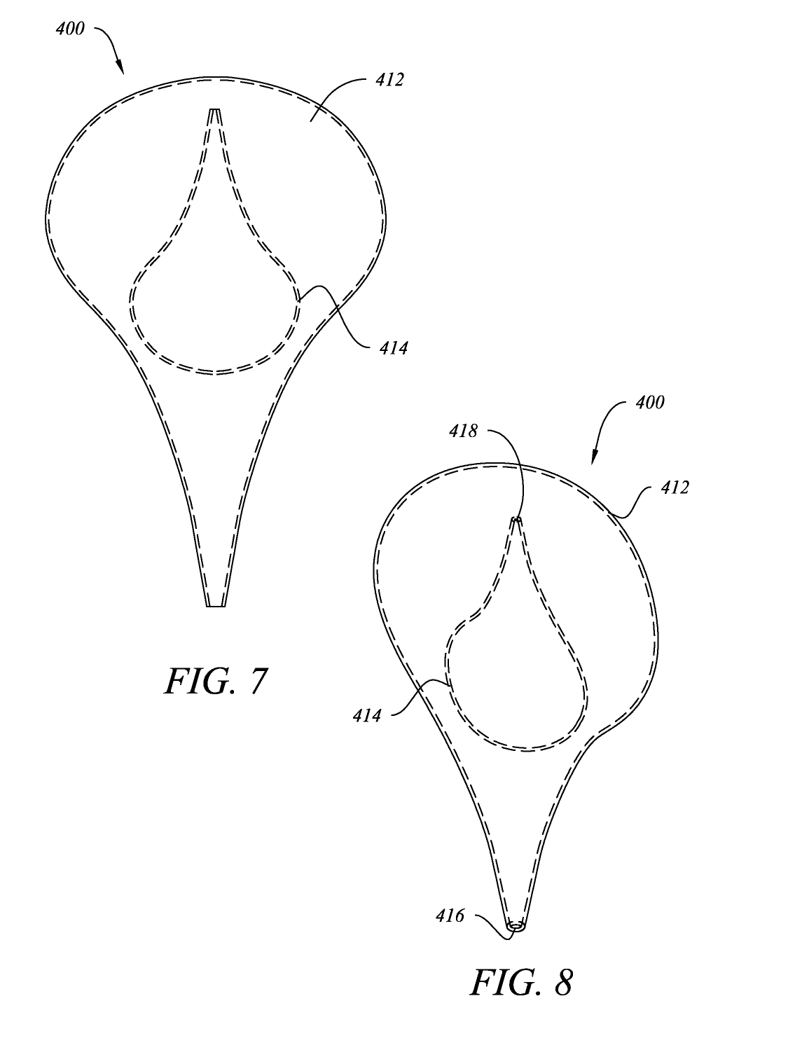

Most preferably, the treatment compositions are included in a bag-in-bag dispersal system, as further described below, but may also be included in a single water soluble container. FIGS. 1-10 show various preferred embodiments of a bag-in-bag delivery system for treatments to be used in a body of water. Each delivery system 100, 200, 300, 400, and 500 depicted comprises an outer container or bag 112, 212, 312, 412, or 512 and an inner container or bag 114, 214, 314, 414, or 514. Each of the inner and outer bags preferably holds a pocket of air or other gas and a treatment composition (preferably one according to the invention) that includes an effervescent couple to aid in dispersing the treatment in the body of water. The bag-in-a-bag configuration employed in these embodiments has advantages over single containment design by allowing for second burst effect for the product dispersion and a second entrapped air pockets with product to ensure float stability (as the inner bag holds air or gas and takes longer to be breached, providing additional floatation to the inner bag after it is breached and beginning to dissolve.

Most preferably, each of the outer bags 112, 212, 312, 412, or 512 and each of the inner container or bags 114, 214, 314, 414, or 514 comprise at least one breach point. The breach point may be an area on the bag that is intended to be easily cut or opened by a user, but most preferably is a thinner area on the bag that will dissolve more quickly than the other areas of the bag when contacted with water. Most preferably, a breach point 116, 216, 316, or 416 on the outer bag is located at a position that is substantially opposite or around 180° from a breach point 118, 218, 318, or 418 on the inner bag, as shown in FIGS. 2, 4, 6, and 8. This enhances the second burst effect for the inner bag. In addition to having a thinner area or breach point, the inner and outer bags may also optionally have a thicker area that is more resistant to breach or that takes longer to dissolve than other portion of the bag. If used, preferably a thicker portion 220, 320 on outer bag 212, 312 is located adjacent to a thinner portion 218, 318, on inner bag 214 314 and a thicker portion 222, 322 on inner bag 214, 314 is located adjacent to thinner portion 216, 316 on outer bag 212, 312, as shown in FIGS. 4 and 6.

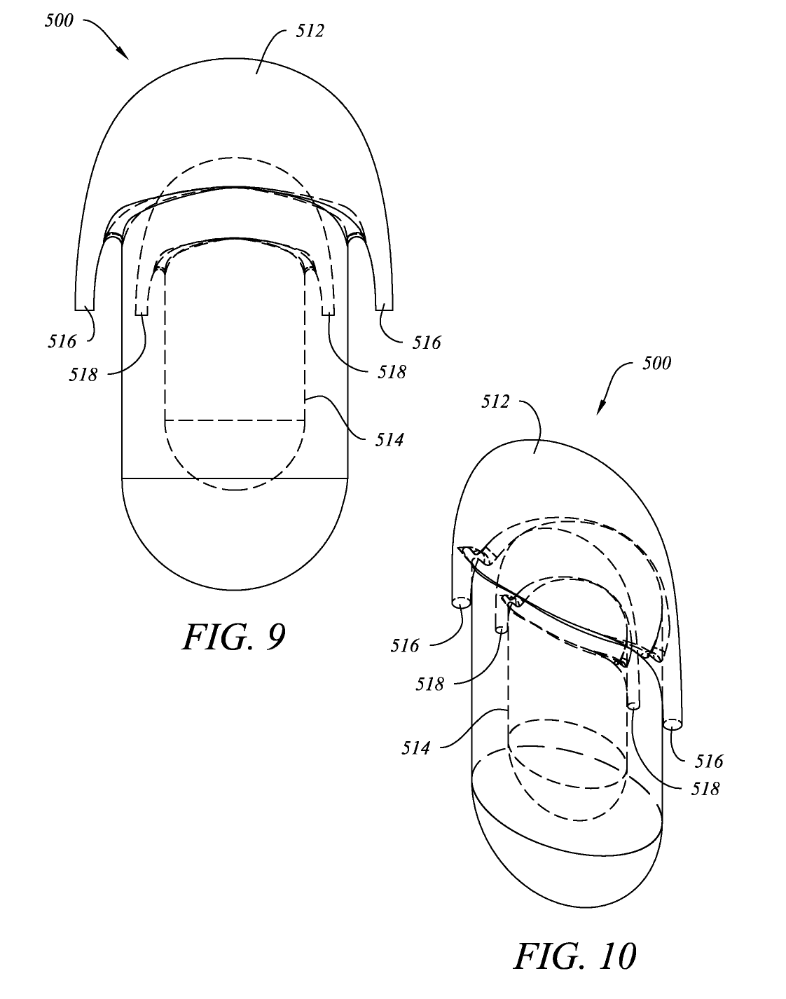

An alternative embodiment is shown in FIGS. 9-10, where each of the outer bag 512 and inner bag 514 comprises at least one and preferably at least two appendages or arms 516 and 518. These arms 516 and 518 are most preferably an area of thinner material or material intended to be mechanically severed (cut or torn open) by a user prior to placing the delivery system 500 in the body of water to act as a breach point. The use of a single appendage 516 and 518, on either the left or right side of delivery system 500, will tend to cause the delivery system 500 to move in a right or left direction when the air or gas (including the carbon dioxide from the reaction of the effervescent couple) escapes from the bags. The use of two arms 516 and 518 positioned on both sides of the outer and inner bags (as depicted in FIG. 9) will tend to cause the delivery system 500 to move in a straighter, forward path when the air or gas escapes. Any combination of appendages may be used and severed and any combinations of location on outer bag 512 and inner bag 514 may be used for placement of these appendages, depending on the desired path or direction of movement of delivery system 500 within the body of water being treated, as will be understood by those of ordinary skill in the art. These appendage allow the user to selectively direct movement of the bag-in-bag container in a preferred general direction within the body of water, if desired.

In addition to the appendages described above, the shape and design of the water-soluble pouches (inter and outer) are also a contributing factor to the movement of the product through the body of water. For example, system 100 is shaped similar to boat to aid in moving or gliding through the water in a more hydrodynamic manner. The shapes depicted in the figures are exemplary only and other shapes may also be used with delivery systems according to the invention.

According to one preferred method of the invention, a body of water is treated with a treatment composition, such as the one described above comprising calcified seaweed, by depositing water soluble containers comprising a treatment composition into the body of water. Most preferably, the treatment composition comprises one or more active ingredients and an effervescent couple, with optional other ingredients in amounts described above with respect to the preferred compositions of the invention. Most preferably, multiple such containers (preferably a bag-in-bag delivery system according to the invention) of the treatment composition are deposited, such as by throwing them into the water, at various locations around the perimeter body of water and at various locations across the length and width of the body of water. The water soluble containers may range in size and weight from smaller, very light-weight sizes to larger pouches weighing from 0.1 to 5 pounds, but are most preferably sized to be easily picked up and thrown a distance into a body of water by the average adult. The use of smaller containers allows for the treatment composition to be easily placed at varying locations around and in or across the body of water from a point along the perimeter or shoreline of the body of water, which was not possible with prior art powdered or slurry treatment compositions. When the containers contact the water, they begin to dissolve and allow the effervescent couple to react and produce carbon dioxide, which aids in dispersing the calcified seaweed. Most preferably, the treatment composition is added to the body of water being with the pre-determined rate is variable based on the active needed to achieve the desired water quality.

When treating cooling towers or similar volumes of circulating water or similar water systems, the preferred method is to reduce conductivity by removing some or substantially all of the water from the water system being treated (if needed) and re-filling with an appropriate amount of fresh or new water, providing a treatment composition (preferably the composition for treating cooling towers as described above), and allowing the treatment composition to contact the components (such as pipes) in the water system being treated (whether circulating or non-circulating) for a period of time, and draining or otherwise removing the water containing the treatment composition from the water system and re-filling with an appropriate volume of fresh or new water. Optionally, a corrosion inhibitor and/or a biocide may also be added, either with the treatment composition (as an integrated product) or as separate components). This method is particularly useful in removing biofilms that have grown on components within the water system.

The composition and method described herein are particularly useful in non-flowing bodies of water, such as ponds or lakes, cooling towers, or other contained bodies of water, such as holding tanks in a wastewater treatment system. However, the composition and method herein may also be useful in moving bodies of water, such as rivers or streams or industrial processes, particularly in areas where the water may be stagnate for periods of time. References herein to additives, active ingredients, or treatment compounds include any type of compound or product or chemical that provides a treatment to a body of water or benefits animals or plants living in or drinking from the body of water, such as improving water quality, improving overall health of the water, or delivering food or probiotics. Those of ordinary skill in the art will also appreciate upon reading this specification and the description of preferred embodiments herein that modifications and alterations to the device may be made within the scope of the invention and it is intended that the scope of the invention disclosed herein be limited only by the broadest interpretation of the appended claims to which the inventors are legally entitled.

1. A composition for treating water, the composition comprising:
an active treatment compound;
an acid; and
a base, wherein the acid and base form an effervescent couple.

2. The composition of claim 1 wherein the composition comprises:
about 0.01 to 80% active treatment compound;
about 10 to 34% acid;
about 20 to 66% base; and
wherein the percentages are by weight.

3. The composition of claim 1 wherein the active treatment compound is calcified seaweed, and the calcified seaweed, acid and base are in a ratio of about 50:16:34 to about 80:6:14.

4. The composition of claim 1 wherein the active treatment compound, acid and base are contained in a water soluble capsule, pouch, or other container.

5. The composition of claim 2 further comprising a dye.

6. The composition of claim 1 wherein the acid is citric acid and the base is sodium bicarbonate.

7. A method of treating a body of water, the method comprising:
providing a treatment composition comprising at least one active ingredient, an acid and a base, wherein the acid and base form an effervescent couple and wherein the treatment composition is formed as a loose powder or pellet contained within a water soluble container; and
dispensing the treatment composition in the body of water by throwing or dropping water soluble containers in the body of water.

8. The method of claim 7 wherein at least two water soluble containers are provided and at least one water soluble container is dispensed at a location within the body of water that is spaced-apart from a location where at least one other water soluble container is dispensed.

9. The method of claim 7 wherein the active ingredient is calcified seaweed, and the calcified seaweed, acid and base are in a ratio of about 50:16:34 to about 80:6:14.

10. The method of claim 7 wherein the water soluble container is a bag-in-bag container comprising an outer water soluble bag and an inner water soluble bag and having the treatment composition and air or gas within the inner bag and the outer bag.

11. The method of claim 10 wherein the active ingredient is calcified seaweed and the treatment composition comprises about 70 to 80% calcified seaweed, about 10 to 34% acid, about 20 to 60% base, and further comprises about 0.5% or less optional additives, wherein the percentages are by weight.

12. The method of claim 7 wherein the body of water is a cooling or chilled water system and the active ingredients remediate biofilm within the cooling or chilled water system.

13. The method of claim 12 wherein the treatment composition comprises: a first chelating agent in a concentration in the range of about 30 ppm to 120 ppm;
a second chelating agent in a concentration in the range of about 680 ppm to 2700 ppm; and
an anionic surfactant in a concentration in the range of about 50 ppm to 200 ppm;
wherein the concentrations are of these ingredients when mixed with a volume of water in the cooling tower or chilled water system being treated.

14. The method according to claim 13 wherein the first chelating agent is an organic acid and the second chelating agent is the corresponding neutral salt of the first chelating agent.

15. The method according to claim 14 wherein the first chelating agent is citric acid and the second chelating agent is sodium citrate.

16. The method according to claim 13 wherein the surfactant is an anionic naphthalene sulfonate compound.

17. The method according to claim 13 further comprising a tolyltriazole compound corrosion inhibitor.

18. The method according to claim 17 wherein the corrosion inhibitor is in a concentration in the range of about 1 ppm to 20 ppm based on the volume of water in the water system being treated.

19. A method of removing biofilm and treating a cooling or chilled water system, the method comprising the steps of:
reducing conductivity by removing some of the water from the water system if there is water in the system and filling the water system with a volume of fresh water;
providing a solid treatment composition than when added to and dissolved in the water in the water system comprises a first chelating agent in a concentration in the range of about 30 ppm to 120 ppm, a second chelating agent in a concentration in the range of about 680 ppm to 2700 ppm, and an anionic surfactant in a concentration in the range of about 50 ppm to 200 ppm; and
contacting the water containing the treatment composition with components of the water system for a period of time.

20. The method of claim 19 further comprising the steps of:
adding a corrosion inhibitor and a secondary biocide to the water in the water system; and
contacting the water containing the corrosion inhibitor and secondary biocide with components of the water system for a period of time.

21. The method of claim 19 further comprising the steps of removing substantially all of the water containing the treatment composition from the water system after it has contacted the components of the water system for a period of time.

22. The method according to claim 19 wherein the first chelating agent is an organic acid and the second chelating agent is the corresponding neutral salt of the first chelating agent.

23. The method according to claim 22 wherein the first chelating agent is citric acid and the second chelating agent is sodium citrate.

24. The method according to claim 19 wherein the surfactant is an anionic compound.

25. The method of claim 19 wherein the solid treatment composition comprises loosely packed solid ingredients within a water soluble container.

26. The method of claim 25 wherein water soluble container is a bag-in-bag container comprising an outer water soluble bag and an inner water soluble bag;
wherein the treatment composition, an acid, a base, and air or gas are contained within the inner bag and the outer bag; and
wherein the acid and base form an effervescent couple.

27. The method of claim 25 wherein the outer bag is has a mechanically severable appendage to aid in initiating an effervescent action by the effervescent couple and to selectively direct movement of the bag-in-bag container.

28. The method of claim 26 wherein the outer bag and inner bag each comprise a breach point and wherein the outer bag breach point is positioned substantially opposite from the inner bag breach point.
